(19) United States
(12) Patent Application Publication
(10) Pub. No.: US 2023/0187622 A1
(43) Pub. Date: Jun. 15, 2023

(54) GRADIENT BASED ELECTRODE STRUCTURE FOR ALL SOLID-STATE LITHIUM-ION BATTERIES

(71) Applicant: HYZON MOTORS INC., Honeoye Falls, NY (US)

(72) Inventors: Rajesh Bashyam, Delta (CA); Zhijun Gu, Naperville, IL (US)

(21) Appl. No.: 18/073,043

(22) Filed: Dec. 1, 2022

Related U.S. Application Data
(60) Provisional application No. 63/289,206, filed on Dec. 14, 2021.

(51) Int. Cl. H01M 4/48; H01M 10/0525; H01M 10/0562; H01M 4/62; H01M 4/58; H01M 4/36

(52) U.S. Cl. CPC H01M 4/483; H01M 4/366; H01M 4/625; H01M 4/5825; H01M 10/0525; H01M 10/0562

(57) ABSTRACT

Ways of making a solid-state lithium-ion battery having a gradient based electrode structure include a separator, the separator comprising a first side and a second side opposite the first side, a positive electrode structure comprising a two-layer gradient, the positive electrode structure alongside the separator on the first side of the separator, an aluminum current collector on the first side of the separator and next to the positive electrode structure, a lithium layer alongside the separator on the second side of the separator, and a copper current collector on the second side of the separator and next to the lithium layer.

### CROSS-REFERENCE TO RELATED APPLICATIONS

This application claims the benefit of U.S. Provisional Application No. 63/289,206, filed on Dec. 14, 2021. The entire disclosure of the above application is hereby incorporated herein by reference.

### FIELD

The present technology includes processes and articles of manufacture that relate to solid-state lithium-ion batteries, including all solid-state lithium-ion batteries having a gradient based electrode structure.

### INTRODUCTION

This section provides background information related to the present disclosure which is not necessarily prior art.

All solid-state batteries are gaining significant attention in lithium-ion battery development due to several advantages, including consistent operation, high energy density, and faster charging properties. However, certain challenges remain to be overcome, especially with respect to solid-state electrolytes, in order to improve conductivity and suppress formation of lithium dendrites. Two main approaches are being employed to develop solid electrolytes, the first being the use inorganic ceramic solid electrolytes and the second being use of a solid polymer electrolyte, where both approaches have their own advantages and disadvantages.

Advantages of all solid-state lithium-ion batteries include high energy density and safety. However, while expectations for solid-state batteries are high, there are still issues related to materials, processing, and engineering to overcome. To increase the energy density of solid-state batteries, the cathode electrode loading and thickness needs to be substantially increased, while this can come with a significant trade-off in the utilization of active materials. What is more, optimized particle size distribution of the active materials in the electrode is needed to achieve good performance, good electrolyte utilization, and cycling stability in solid-state based batteries. Currently, in most cases, the cathode active material loading in the electrode is between two and five milligrams per square centimeter to minimize the trade off in utilization efficiency; however, such loading may not provide performance viable for commercial vehicular battery applications.

Accordingly, there is a need to increase the lithium-ion transport and conductivity in a relatively thick cathode electrode and minimize the trade off in performance.

### SUMMARY

In concordance with the instant disclosure, ways to increase the lithium-ion transport and conductivity in an electrode and address challenges associated with cathode electrode design and processing, are surprisingly discovered.

A gradient electrode structure for a solid-state lithium battery is provided that includes a first layer, a second layer, and a third layer, where the second layer is disposed between the first layer and the third layer. The first layer includes a solid electrolyte. The second layer includes a cathode active material, a lithiated ionomer, and an electrically conductive additive. The third layer also includes the cathode active material, the lithiated ionomer, and the electrically conductive additive. An amount of the cathode active material in the third layer is less than an amount of the cathode active material in the second layer. An amount of the lithiated ionomer in the third layer is greater than an amount of the lithiated ionomer in the second layer. An amount of the electrically conductive additive in the third layer is less than an amount of the electrically conductive additive in the second layer.

Ways of making and using a gradient electrode structure for a solid-state lithium-ion battery are provided. A first layer including a solid electrolyte is provided. A second layer including a cathode active material, a lithiated ionomer, and an electrically conductive additive is formed. A third layer including the cathode active material, the lithiated ionomer, and the electrically conductive additive is formed. An amount of the cathode active material in the third layer is less than an amount of the cathode active material in the second layer, an amount of the lithiated ionomer in the third layer is greater than an amount of the lithiated ionomer in the second layer, and an amount of the electrically conductive additive in the third layer is less than an amount of the electrically conductive additive in the second layer. The second layer is disposed between the first layer and the third layer.

Various gradient electrode structures for solid-state batteries can be made according to the present technology. Likewise, various solid-state batteries can include or be manufactured using the gradient electrode structures provided by the present technology.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic cross-sectional design of an embodiment of a gradient electrode structure for a solid-state lithium-ion battery, in accordance with the present technology; and

FIG. 2 is a schematic flowchart of a method of making a gradient electrode structure for a solid-state lithium-ion battery, in accordance with the present technology.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature’s relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology relates to increasing lithium-ion transport and increasing conductivity in an electrode for a solid-state lithium battery and addressing challenges associated with cathode electrode design and processing within a solid-state lithium-ion battery. Controlling a positive or cathode electrode structure can be an important aspect for high-performance solid-state batteries. In accordance with the present technology, a gradient electrode structure can be made of multiple layers having different amounts of cathode active material. The present technology can enable the gradient electrode structure to load more active material and improve the utilization of the active material across the layers of the electrode. The resulting gradient electrode structure can accordingly provide optimized ionic and electronic conductivities, thereby improving performance of a solid-state lithium battery incorporating such layers having different amounts of cathode active material.

A gradient electrode structure for a solid-state lithium battery is provided that includes a first layer, a second layer, and a third layer, where the second layer is disposed between the first layer and the third layer. The first layer includes a solid electrolyte. The second layer includes a cathode active material, a lithiated ionomer, and an electrically conductive additive. The third layer includes the cathode active material, the lithiated ionomer, and the electrically conductive additive, with the following caveats: an amount of the cathode active material in the third layer is less than an amount of the cathode active material in the second layer, an amount of the lithiated ionomer in the third layer being greater than an amount of the lithiated ionomer in the second layer, and an amount of the electrically conductive additive in the third layer being less than an amount of the electrically conductive additive in the second layer.

The solid electrolyte of the first layer can include the following aspects. The solid electrolyte can include a lithiated compound. The compound can include one or more various anionic groups that can associate with one or more lithium ions to form the lithiated compound. Certain embodiments of the lithiated compound include a lithiated perfluorosulfonic acid. Examples of lithiated perfluorosulfonic acids include one or more lithiated versions of trifluoromethanesulfonic acid, perfluoroethanesulfonic acid, perfluoropropaneesulfonic acid, perfluorobutanesulfonic acid, perfluoropentanesulfonic acid, perfluorohexanesulfonic acid, perfluoroheptanesulfonic acid, perfluorooctanesulfonic acid, perfluorononanesulfonic acid, and perfluorodecanesulfonic acid. Certain embodiments include where the lithiated compound includes a lithiated perfluorosulfonic acid ion-exchange membrane. The lithiated perfluorosulfonic acid ion-exchange membrane can have an equivalent weight of 300 to 1,100.

The cathode active material of the second layer and the third layer can include the following aspects. The cathode active material can include a metal oxide and/or a metal phosphate. The metal oxide can include one or more of cobalt oxide, iron oxide, manganese oxide, and nickel oxide. The metal phosphate can include one or more of cobalt phosphate, iron phosphate, manganese phosphate, and nickel phosphate.

The lithiated ionomer of the second layer and the third layer can include the following aspects. The lithiated ionomer can include a lithiated compound, where the lithiated compound can include one or more lithiated perfluorosulfonic acids. Examples of lithiated perfluorosulfonic acids include one or more lithiated versions of trifluoromethanesulfonic acid, perfluoroethanesulfonic acid, perfluoropropaneesulfonic acid, perfluorobutanesulfonic acid, perfluoropentanesulfonic acid, perfluorohexanesulfonic acid, perfluoroheptanesulfonic acid, perfluorooctanesulfonic acid, perfluorononanesulfonic acid, and perfluorodecanesulfonic acid.

The electrically conductive additive of the second layer and the third layer can include the following aspects. Examples of the electrically conductive additive include carbon, carbon microfibers, carbon nanofibers, carbon nanotubes, graphite nanofibers, and graphene. Mixtures of various electrically conductive additives can be used.

The second layer and the third layer can include the following aspects to provide one more gradients of materials therebetween. The second layer can include from greater than 50% up to 80% of the total cathode active material in the second layer and the third layer. The second layer can also include from greater than 0% up to 5% of the lithiated ionomer. Still further, the second layer can have from 10% to 20% of the electrically conductive additive. The third layer can include from 20% up to less than 50% of the total cathode active material in the second layer and the third layer. The third layer can also include from 5% to 20% of the lithiated ionomer. Still further, the third layer can have from 1% to 3% of the electrically conductive additive.

The gradient electrode structure can further include the following aspects. A fourth layer can be provided adjacent the first layer and opposite the second layer, where the fourth layer includes a metal layer. The metal layer can include a lithium layer. The metal layer can further include a copper layer, where the lithium layer is adjacent the first layer. The lithium layer can be directly adjacent the first layer. A fifth layer can be provided adjacent the third layer and opposite the second layer, where the fifth layer can include a metal layer. The metal layer of the fifth layer can include an aluminum layer.

The present technology further contemplates various constructs and devices incorporating the gradient electrode structure for a solid-state lithium battery. In particular, various types of solid-state lithium batteries can include various configurations of the gradient electrode structure. Examples include where the layers of the gradient electrode structure are parallel, curved, bent, rolled (e.g., Archimedean spiral), folded, or otherwise configured for assembly into a predetermined battery cell shape, such as various polyhedral battery cells, cylindrical battery cells, coin battery cells, and flat or pouch battery cells. Batteries can also include configurations of multiple electrically connected cells.

Solid-state lithium batteries including the gradient electrode structure can be used in various applications. Examples include various consumer electronic devices, energy storage applications, and transportation applications. Solid-state lithium batteries using the gradient electrode structure can find particular application in battery powered, fuel cell powered, and hybrid powered vehicles including trucks, buses, and passenger vehicles.

Ways of making a gradient electrode structure for a solid-state lithium battery are also provided by the present technology. These include providing a first layer including a solid electrolyte. A second layer is formed that includes a cathode active material, a lithiated ionomer, and an electrically conductive additive. A third layer is formed that includes the cathode active material, the lithiated ionomer, and the electrically conductive additive. An amount of the cathode active material in the third layer is less than an amount of the cathode active material in the second layer, an amount of the lithiated ionomer in the third layer is greater than an amount of the lithiated ionomer in the second layer, and an amount of the electrically conductive additive in the third layer is less than an amount of the electrically conductive additive in the second layer. The second layer is disposed between the first layer and the third layer.

Ways of making a gradient electrode structure for a solid-state lithium battery can further include the following aspects. A fourth layer can be disposed adjacent the first layer and opposite the second layer, where the fourth layer includes a first metal layer. A fifth layer can be disposed adjacent the third layer and opposite the second layer, where the fifth layer includes a second metal layer.

The present technology can provide certain benefits and advantages in all lithium-ion solid-state batteries, including batteries used for various portable and mobility applications such as vehicles. Several issues with respect to lithium-ion batteries are addressed by the present technology, including increasing the lithium-ion transport and conductivity in the electrode and also addressing challenges associated with cathode electrode design and processing. In particular, utilizing a positive electrode comprising the multilayer gradient and controlling the electrode structure in this way can optimize performance through enhanced lithium and electrical pathways and can increase cycling stability.

### EXAMPLES

Example embodiments of the present technology are provided with reference to the figures enclosed herewith.

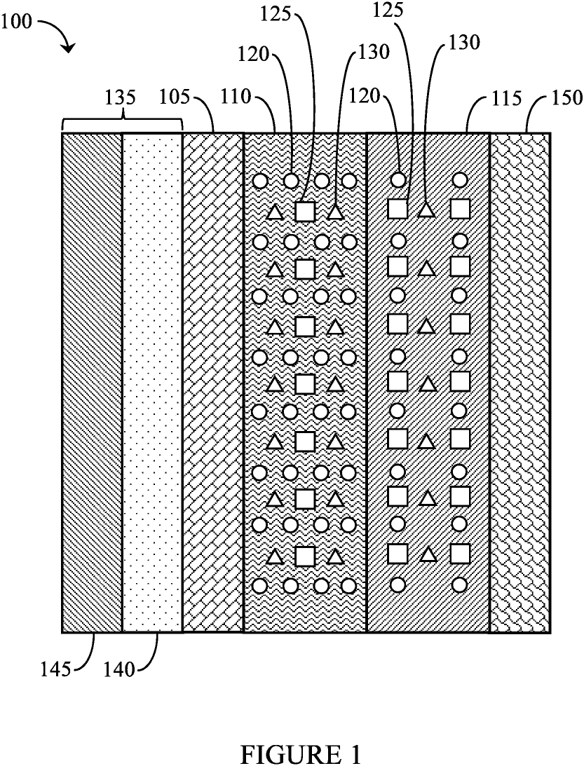

With reference to FIG. 1, an embodiment of a gradient electrode structure is shown at 100. A first layer 105, a second layer 110, and a third layer 115 are provided. The first layer 105 includes a solid electrolyte; e.g., a lithiated compound. The second layer 110 includes a cathode active material 120 (e.g., a metal oxide or a metal phosphate), a lithiated ionomer 125 (e.g., a lithiated perfluorosulfonic acid), and an electrically conductive additive 130 (e.g., carbon, carbon microfibers, carbon nanofibers, carbon nanotubes, graphite nanofibers, graphene). The third layer 115 includes the cathode active material 120, the lithiated ionomer 125, and the electrically conductive additive 130. An amount of the cathode active material 120 in the third layer 115 is less than an amount of the cathode active material 120 in the second layer 110. An amount of the lithiated ionomer 125 in the third layer 115 is greater than an amount of the lithiated ionomer 125 in the second layer 110. An amount of the electrically conductive additive 130 in the third layer 115 is less than an amount of the electrically conductive additive 130 in the second layer 110. As shown, the second layer 110 is disposed between the first layer 105 and the third layer 115. The second layer 110 can directly contact the first layer 105 and can directly contact the third layer 115.

A fourth layer 135 is provided that includes a metal layer. The fourth layer 135 is disposed adjacent the first layer 105 and opposite the second layer 110. In this way, the first layer 105 can directly contact the second layer 110 and the fourth layer 135. In the embodiment shown, the metal layer of the fourth layer 135 can include a lithium layer 140 and a copper layer 145, where the lithium layer 135 is disposed adjacent the first layer 105. In this way, the lithium layer 140 can directly contact the first layer 105 including the solid electrolyte.

A fifth layer 150 is provided that includes a metal layer; e.g., an aluminum layer. The fifth layer 150 is disposed adjacent the third layer 115 and opposite the second layer 110. In this way, the third layer 115 can directly contact the second layer 110 and the fifth layer 150.

It should be appreciated that while the embodiment shown in FIG. 1 is depicted as having generally parallel layers, it is understood that the gradient electrode structure can be configured in various ways to form various lithium battery architectures. Examples include where the respective layers are curved, bent, rolled (e.g., Archimedean spiral), folded, or otherwise configured for assembly into a predetermined battery cell shape, such as various polyhedral battery cells, cylindrical battery cells, coin battery cells, and flat or pouch battery cells. Batteries can also include multiple electrically connected cells.

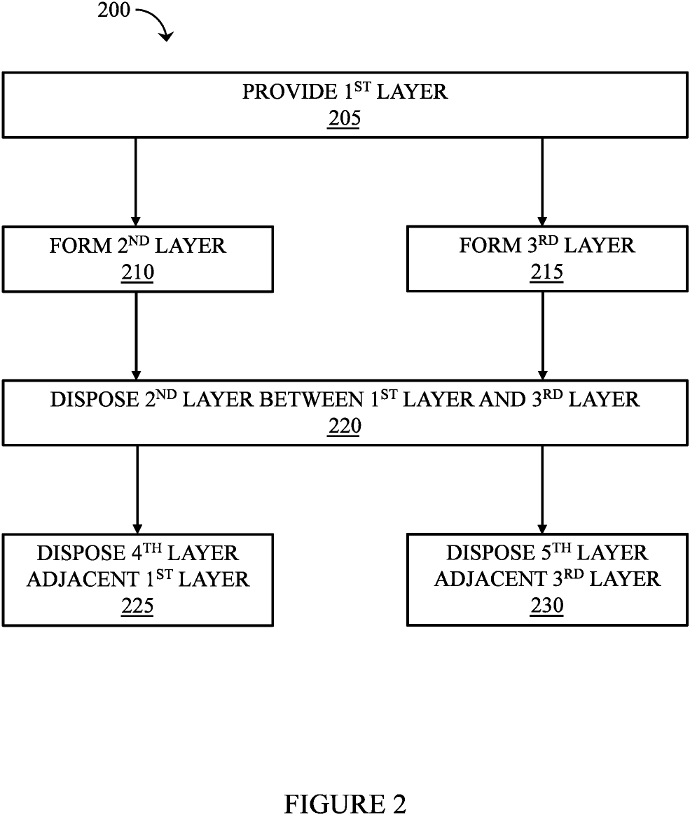

With reference to FIG. 2, an embodiment of a method of making a gradient electrode structure is shown at 200. Step 205 includes providing a first layer including a solid electrolyte. Step 210 involves forming a second layer including a cathode active material, a lithiated ionomer, and an electrically conductive additive. Step 215 provides for forming a third layer including the cathode active material, the lithiated ionomer, and the electrically conductive additive, with the caveats that: an amount of the cathode active material in the third layer is less than an amount of the cathode active material in the second layer, an amount of the lithiated ionomer in the third layer is greater than an amount of the lithiated ionomer in the second layer, and an amount of the electrically conductive additive in the third layer is less than an amount of the electrically conductive additive in the second layer. Step 220 includes disposing the second layer between the first layer and the third layer. Step 225 involves disposing a fourth layer adjacent the first layer and opposite the second layer, the fourth layer including a first metal layer. And step 230 provides for disposing a fifth layer adjacent the third layer and opposite the second layer, the fifth layer including a second metal layer. The first, second, third, fourth, and fifth layers can include the various aspects as described herein.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A gradient electrode structure for a solid-state lithium battery, comprising:
a first layer including a solid electrolyte;
a second layer including a cathode active material, a lithiated ionomer, and an electrically conductive additive; and
a third layer including the cathode active material, the lithiated ionomer, and the electrically conductive additive, an amount of the cathode active material in the third layer being less than an amount of the cathode active material in the second layer, an amount of the lithiated ionomer in the third layer being greater than an amount of the lithiated ionomer in the second layer, and an amount of the electrically conductive additive in the third layer being less than an amount of the electrically conductive additive in the second layer;
wherein the second layer is disposed between the first layer and the third layer.

2. The gradient electrode structure for a solid-state lithium battery of claim 1, wherein the solid electrolyte includes a lithiated compound.

3. The gradient electrode structure for a solid-state lithium battery of claim 2, wherein the lithiated compound includes a lithiated perfluorosulfonic acid.

4. The gradient electrode structure for a solid-state lithium battery of claim 1, wherein the cathode active material includes one of a metal oxide and a metal phosphate.

5. The gradient electrode structure for a solid-state lithium battery of claim 4, wherein the cathode active material includes the metal oxide and the metal oxide includes a member selected from a group consisting of cobalt oxide, iron oxide, manganese oxide, and nickel oxide.

6. The gradient electrode structure for a solid-state lithium battery of claim 4, wherein cathode active material includes the metal phosphate and the metal phosphate includes a member selected from a group consisting of cobalt phosphate, iron phosphate, manganese phosphate, and nickel phosphate.

7. The gradient electrode structure for a solid-state lithium battery of claim 1, wherein the lithiated ionomer includes a lithiated perfluorosulfonic acid.

8. The gradient electrode structure for a solid-state lithium battery of claim 1, wherein the electrically conductive additive includes a member selected from a group consisting of carbon, carbon microfibers, carbon nanofibers, carbon nanotubes, graphite nanofibers, and graphene.

9. The gradient electrode structure for a solid-state lithium battery of claim 1, wherein the second layer includes:
from greater than 50% up to 80% of a total of the cathode active material in the second layer and the third layer;
from greater than 0% up to 5% of the lithiated ionomer; and
from 10% to 20% of the electrically conductive additive.

10. The gradient electrode structure for a solid-state lithium battery of claim 1, wherein the third layer includes:
from 20% up to less than 50% of the total of the cathode active material in the second layer and the third layer;
from 5% to 20% of the lithiated ionomer; and
from 1% to 3% of the electrically conductive additive.

11. The gradient electrode structure for a solid-state lithium battery of claim 1, further comprising a fourth layer adjacent the first layer and opposite the second layer, the fourth layer including a metal layer.

12. The gradient electrode structure for a solid-state lithium battery of claim 11, wherein the metal layer includes a lithium layer.

13. The gradient electrode structure for a solid-state lithium battery of claim 12, wherein the metal layer further includes a copper layer, and the lithium layer is adjacent the first layer.

14. The gradient electrode structure for a solid-state lithium battery of claim 1, further comprising a fifth layer adjacent the third layer and opposite the second layer, the fifth layer including a metal layer.

15. The gradient electrode structure for a solid-state lithium battery of claim 14, wherein the metal layer includes an aluminum layer.

16. A solid-state lithium battery comprising the gradient electrode structure of claim 1.

17. A gradient electrode structure for a solid-state lithium battery, comprising:
a first layer including a solid electrolyte;
a second layer including a cathode active material, a lithiated ionomer, and an electrically conductive additive;
a third layer including the cathode active material, the lithiated ionomer, and the electrically conductive additive, an amount of the cathode active material in the third layer being less than an amount of the cathode active material in the second layer, an amount of the lithiated ionomer in the third layer being greater than an amount of the lithiated ionomer in the second layer, and an amount of the electrically conductive additive in the third layer being less than an amount of the electrically conductive additive in the second layer, wherein the second layer is disposed between the first layer and the third layer;
a fourth layer adjacent the first layer and opposite the second layer, the fourth layer including a lithium layer and a copper layer, the lithium layer adjacent the first layer; and
a fifth layer adjacent the third layer and opposite the second layer, the fifth layer including an aluminum layer;
wherein:
the solid electrolyte includes a lithiated perfluorosulfonic acid;
the cathode active material includes one of a metal oxide and a metal phosphate;
the lithiated ionomer includes a lithiated perfluorosulfonic acid;
the electrically conductive additive includes a member selected from a group consisting of carbon, carbon microfibers, carbon nanofibers, carbon nanotubes, graphite nanofibers, and graphene;
the second layer includes:
from greater than 50% up to 80% of a total of the cathode active material in the second layer and the third layer;
from greater than 0% up to 5% of the lithiated ionomer;
from 10% to 20% of the electrically conductive additive; and
the third layer includes:
from 20% up to less than 50% of the total of the cathode active material in the second layer and the third layer;
from 5% to 20% of the lithiated ionomer; and
from 1% to 3% of the electrically conductive additive;.

18. A method of making a gradient electrode structure for a solid-state lithium battery, comprising:
providing a first layer including a solid electrolyte;
forming a second layer including a cathode active material, a lithiated ionomer, and an electrically conductive additive;
forming a third layer including the cathode active material, the lithiated ionomer, and the electrically conductive additive, an amount of the cathode active material in the third layer being less than an amount of the cathode active material in the second layer, an amount of the lithiated ionomer in the third layer being greater than an amount of the lithiated ionomer in the second layer, and an amount of the electrically conductive additive in the third layer being less than an amount of the electrically conductive additive in the second layer; and
disposing the second layer between the first layer and the third layer.

19. The method of claim 18, further comprising disposing a fourth layer adjacent the first layer and opposite the second layer, the fourth layer including a first metal layer.

20. The method of claim 19, further comprising disposing a fifth layer adjacent the third layer and opposite the second layer, the fifth layer including a second metal layer.
